(19) United States
(12) Patent Application Publication
(10) Pub. No.: US 2021/0157792 A1
(43) Pub. Date: May 27, 2021

(54) TECHNIQUE FOR MANAGING DATA IN A BLOCKCHAIN NETWORK

(71) Applicant: TmaxBI Co., Ltd., Gyeonggi-do (KR)

(72) Inventors: Myongsik Gong, Gyeonggi-do (KR); Giwoong Kim, Gyeonggi-do (KR); Dongyoung Min, Gyeonggi-do (KR); Seokwoo Ahn, Seoul (KR); Hyochang Yang, Gyeonggi-do (KR); Kangmin Yoo, Chungcheongbuk-do (KR); Hansol Lee, Gyeonggi-do (KR); Jaeyeong Choi, Busan (KR); Junghoon Hah, Gyeonggi-do (KR)

(73) Assignee: TmaxBI Co., Ltd.

(21) Appl. No.: 16/950,466

(22) Filed: Nov. 17, 2020

(30) Foreign Application Priority Data
Nov. 22, 2019 (KR) 10-2019-0151122

(51) Int. Cl. G06F 16/23; G06F 16/22

(52) U.S. Cl. CPC G06F 16/2379; G06F 16/2255; G06F 16/2282

(57) ABSTRACT

A computer program stored in a computer readable storage medium includes commands which cause a processor of a node included in the blockchain network to execute steps. The steps comprising: recording at least a first transaction in a transaction table and a first body table when at least one first transaction occurs; generating header information for at least the first transaction when a preset condition is satisfied; recording the header information in a header table; and transmitting a signal including the first transaction and the header information to at least one node included in the blockchain network so that the first transaction is recorded in a second body table of each of a plurality of nodes included in the blockchain network and the header information is recorded in the second header table of each of a plurality of nodes included in the blockchain network.

### TECHNICAL FIELD

The present disclosure relates to a technique for managing data in a blockchain network, and particularly, to a method of managing data in a blockchain network by utilizing a database management system.

### BACKGROUND ART

Recently, the 4^{th} Industrial Revolution, which is a next generation industrial revolution through the convergence of information and communication technologies, is becoming an issue. In the existing industry, automation means passive operation according to a pre-input program, but in the 4^{th} Industrial Revolution, the automation means that machines actively grasp the situation and operate and the 4^{th} Industrial Revolution is led by artificial intelligence, robot technology, life science, and the like.

Among the technologies of the 4^{th} Industrial Revolution, blockchain is attracting attention as a main technology. The blockchain is the technology providing security as a public transaction ledger. As blockchain is attracting attention, a bitcoin platform and an Ethereum platform, which are blockchain-based cryptocurrency technologies, are also attracting attention.

Bitcoin refers to a cryptocurrency that can record transaction records by using the blockchain technology, and ether in Ethereum refers to a cryptocurrency that can record additional information, such as a contract, as well as transaction technology. Particularly, Ethereum supports a smart contract function that can record separate information, thereby attracting more attention.

However, the existing blockchain technology has a structure in which data is stored in the form of a file, so that there is a problem in that a data input/output speed is low and data lookup speed is low. Accordingly, there is a need for a blockchain technology with improved data input/output speed and data lookup speed. Further, there is a problem in that it is difficult to record large data in a blockchain network. Accordingly, there is a need in the art for a method of recording large data in a blockchain network.

### PRIOR ART LITERATURE

### Patent Document

Korean Patent No. 10-1852935
Korean Patent No. 10-1954268

### SUMMARY OF THE INVENTION

The present disclosure is conceived in response to the background art, and has been made in an effort to provide a blockchain network system with improved data input/output speed and data lookup speed.

The technical objects of the present disclosure are not limited to the foregoing technical objects, and other non-mentioned technical objects will be clearly understood by those skilled in the art from the description below.

An exemplary embodiment of the present disclosure for solving the problem discloses a computer program stored in a computer readable storage medium. The computer program includes commands which cause a processor of a node included in the blockchain network to execute steps, the steps comprising: recording the at least one first transaction in a transaction table and a first body table when at least one first transaction occurs; generating first header information for the at least one first transaction when a preset condition is satisfied; recording the first header information in a first header table; and transmitting a signal including the at least one first transaction and the first header information to at least one node included in the blockchain network so that the at least one first transaction is recorded in a second body table of each of a plurality of nodes included in the blockchain network and the first header information is recorded in the second header table of each of a plurality of nodes included in the blockchain network.

The first header information comprises at least one of a time stamp indicating a time when the first header information is generated, generation node information for a node that generates the first header information or first identification information for identifying the first header information, wherein each of the transaction table and the first body table comprises a first transaction table column in which the at least one first transaction is recorded, and a second transaction table column in which identification information on header information mapped to each of the at least one first transaction recorded in each transaction table row of the transaction table is recorded, wherein the first header table comprises a first header table column in which the first identification information is recorded, a second header table column in which a hash value of previous header information is recorded, and a third header table column in which a hash value of the current header information is recorded.

The recording the first header information in a first header table further comprises: recording the first identification information in at least one first data cell corresponding to at least one first transaction table row and the second transaction table column in the transaction table, wherein the at least one first transaction table row is a transaction table row in which the at least one first transaction is recorded in the transaction table; recording a null value in a second data cell corresponding to the second header table column and the first header table row in which the first header information is recorded; and recording a null value in a third data cell corresponding to the third header table column and the first header table row.

The steps further comprise: calculating a first hash value to be input to the first header information when performing consensus based on a preset consensus algorithm; recognizing second header information having an order faster than that of the first header information based on a preset protocol; recognizing a second hash value, which is a hash value of current header information input to the second header information; transmitting the first hash value and the second hash value to the at least one node included in the blockchain network, thereby recognizing whether a consensus has been completed; and when consensus is complete, recording the second hash value to the second data cell and recording the first hash value to the third data cell.

The calculating a first hash value to be input to the first header information when performing consensus based on a preset consensus algorithm comprises: checking whether the first header information recorded in the first header table is recorded in the second header table of each of a plurality of nodes included in the blockchain network when a preset consensus condition is satisfied; and calculating the first hash value when the first header information is recorded in the second header table.

The preset consensus condition is satisfied at a preset time interval or when the number of uncommitted header information existing in the second header table exceeds a preset number.

The calculating the first hash value when the first header information is recorded in the second header table comprises: searching for at least one transaction related to the first header information in a transaction table of the node using the first identification information; and hashing the at least one transaction based on a preset hash algorithm to calculate the first hash value.

The checking whether the first header information recorded in the first header table is recorded in the second header table of each of a plurality of nodes included in the blockchain network when a preset consensus condition is satisfied comprises: transmitting a first signal to the plurality of nodes to check whether the first header information is recorded in the second header table; receiving a second signal from the plurality of nodes in response to the first signal; and checking whether the first header information is recorded in the second header table based on the second signal, and wherein the second signal comprises node identification information for the node that transmitted the second signal, and identifier indicating whether the first header information is recorded in the second header table.

The checking whether the first header information is recorded in the second header table based on the second signal further comprises: recognizing the first node based on the node identification information when the second signal received from the first node among the plurality of nodes includes a first identifier indicating that the first header information is not recorded in the header table of the first node; and transmitting the first header information and at least one first transaction related to the first header information to the first node.

The calculating the first hash value when the first header information is recorded in the second header table further comprises: recognizing that the first header information is recorded in the second header table when the second signal received from the plurality of nodes includes a second identifier indicating that the first header information is recorded in the first header table.

The first hash value is a value obtained by hashing the at least one first transaction using a preset hash algorithm, and wherein the second hash value is a value obtained by hashing at least one transaction related to the second header information using the preset hash algorithm.

The preset condition is satisfied at a preset time interval or when the number of the at least one first transaction recorded in the transaction table exceeds a preset number.

The recording the at least one first transaction in a transaction table and a first body table when at least one first transaction occurs further comprises: checking whether the size of the file exceeds a preset size when receiving a command to record a file to the blockchain network; and determining a method of recording a second transaction including the file in the transaction table and the first body table based on whether the size of the file exceeds the preset size, and wherein the transaction table and the first body table comprises a first transaction table column in which the at least one first transaction is recorded, a second transaction table column in which identification information on header information mapped to each of the at least one first transaction recorded in each transaction table row of the transaction table is recorded and a third transaction table column for recording location information indicating a location where the file is recorded in a storage unit of the node.

The determining a method of recording a second transaction including the file in the transaction table and the first body table based on whether the size of the file exceeds the preset size comprises: recording data representing the file in binary format in a fourth data cell of the first transaction table column when the size of the file is less than or equal to the preset size; and recording a null value to a fifth data cell of a third transaction table column positioned in a same row as the fourth data cell.

The determining a method of recording a second transaction including the file in the transaction table and the first body table based on whether the size of the file exceeds the preset size comprises: recognizing a hash value that hashed the file through a preset hash algorithm when the size of the file exceeds the preset size; recording the file in a storage unit; recording the hash value to a fourth data cell of the first transaction table column of the transaction table; and recording the location information in a fifth data cell of the third transaction table column located in a same row as the fourth data cell.

The at least one first transaction comprises the second transaction including the file, wherein the transmitting a signal including the at least one first transaction and the first header information to at least one node included in the blockchain network further comprises: checking a setting for whether to share the file; and determining whether to transmit the file together with the at least one first transaction including the second transaction and the first header information to the at least one node according to the setting.

The determining whether to transmit the file together with the at least one first transaction including the second transaction and the first header information to the at least one node according to the setting comprises: transmitting the file to the at least one node together with the at least one first transaction including the second transaction and the first header information when a first setting of sharing the file is set.

The determining whether to transmit the file together with the at least one first transaction including the second transaction and the first header information to the at least one node according to the setting comprises: determining not to transmit the file to the at least one node when a second setting of not sharing the file is set.

The recording the location information in a fifth data cell of the third transaction table column located in a same row as the fourth data cell comprises: checking a setting for whether to share the file; and recording the location information in the fifth data cell when the first setting of sharing the file is set.

The recording the location information in a fifth data cell of the third transaction table column located in a same row as the fourth data cell comprises: checking a setting for whether to share the file; and recording a null value to the fifth data cell instead of the location information when a second setting of not sharing the file is set.

The technical solutions obtainable from the present disclosure are not limited to the foregoing solutions, and other non-mentioned solution will be clearly understood by those skilled in the art from the description below.

According to the exemplary embodiments of the present disclosure, it is possible to provide the blockchain network system with improved data input/output speed and data lookup speed.

The effects obtainable from the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters.

FIG. 1 is a schematic diagram illustrating a blockchain network system according to exemplary embodiments of the present disclosure.

FIG. 2 is a block diagram illustrating nodes configuring the blockchain network system according to exemplary embodiments of the present disclosure.

FIG. 3 is a diagram for describing a transaction table recorded in a storage unit of each of a plurality of nodes included in a blockchain network according to exemplary embodiments of the present disclosure.

FIG. 4 is a diagram for describing a header table recorded in a storage unit of each of a plurality of nodes included in the blockchain network according to exemplary embodiments of the present disclosure.

FIG. 5 is a flowchart for describing an example of a method of recording a transaction in a transaction table and recording header information in a header table by a node according to exemplary embodiments of the present disclosure.

FIGS. 6 to 8 are diagrams for describing an example of a method of recording a transaction in a transaction table and recording header information in a header table by the node according to exemplary embodiments of the present disclosure.

FIG. 9 is a flowchart for describing an example of a method of committing the header information recorded in the header table based on a preset consensus algorithm according to exemplary embodiments of the present disclosure.

FIG. 10 is a diagram for describing an example of the method of committing the header information recorded in the header table based on the preset consensus algorithm according to exemplary embodiments of the present disclosure.

FIG. 11 is a flowchart for describing an example of a method of recording at least one transaction and header information in the case where the node receives a signal including at least one transaction and header information from another node according to exemplary embodiments of the present disclosure.

FIG. 12 is a flowchart for describing an example of a method of recording, by the node, a transaction including a file in the blockchain network according to exemplary embodiments of the present disclosure.

FIG. 13 is a diagram for describing an example of a method of recording, by the node, a transaction including a file in the blockchain network according to exemplary embodiments of the present disclosure.

FIG. 14 is a general schematic diagram illustrating an example of a computing environment in which the exemplary embodiments of the present disclosure contents are implementable.

### DETAILED DESCRIPTION

Various exemplary embodiments and/or aspects are now disclosed with reference to the drawings. In the description below, the plurality of particular detailed matters are disclosed for helping general understanding of one or more aspects for the purpose of description. However, the point that the aspect(s) is executable even without the particular detailed matters may also be recognized by those skilled in the art. The subsequent description and the accompanying drawings describe specific illustrative aspects of one or more aspects in detail. However, the aspects are illustrative, and some of the various methods of various aspects of the principles may be used, and the descriptions intend to include all of the aspects and the equivalents thereof. In particular, an “exemplary embodiment”, an “example”, an “aspect”, an “illustration”, and the like used in the present specification may not be construed to be better or have an advantage compared to a predetermined described aspect, an aspect having a different design, or designs.

Hereinafter, the same or similar constituent element is denoted by the same reference numeral regardless of a reference numeral, and a repeated description thereof will be omitted. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings.

Although “a first”, “a second”, and the like are used for describing various elements or constituent elements, the elements or the constituent elements are not limited by the terms. The terms are used for discriminating one element or constituent element from another element or constituent element. Accordingly, a first element or constituent element mentioned below may also be a second element or constituent element within the technical spirit of the present disclosure as a matter of course.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly and specially defined.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Terms “information” and “data” used in the present specification may be frequently used to be exchangeable with each other.

Suffixes, “ . . . module” and “ . . . unit” for a constituent element used for the description below are given or mixed in consideration of only easiness of the writing of the specification, and the suffix itself does not have a discriminated meaning or role.

An object and effect of the present disclosure and technical configurations for achieving them will be apparent with reference to the exemplary embodiments described below in detail together with the accompanying drawings. In describing the present disclosure, when it is determined that detailed description of known function or configurations unnecessarily obscures the subject matter of the present disclosure, the detailed description may be omitted. Further, the terms used in the description are defined in consideration of the function in the present disclosure and may vary depending on an intention or usual practice of a user or operator.

However, the present disclosure is not limited to the exemplary embodiments disclosed below, but may be implemented in various different forms. However, the present exemplary embodiments are provided only to make the present disclosure complete, and to fully inform the scope of the disclosure to those skilled in the art, and the present disclosure is only defined by the scope of the claims. Accordingly, the definition should be made based on the content throughout the present specification.

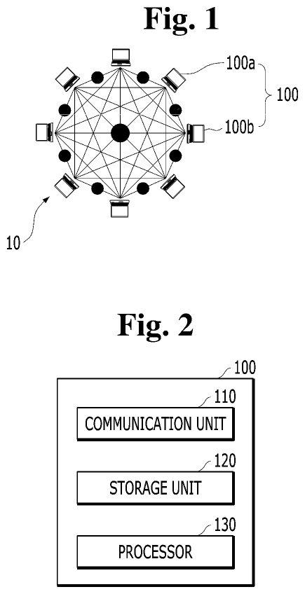

A general blockchain network may store a transaction in a block in the form of a file, not the form of a table, when recording the transaction in the block. Accordingly, an existing blockchain network may have a problem in that a data input/output speed is low and it is difficult to look up data. In the meantime, the blockchain network system according to the exemplary embodiments of the present disclosure may record a transaction in the form of a table used in a Database Management System (DBMS), and record header information, which is recorded in a block header of an existing blockchain network, in the form of a table used in the DBMS. That is, according to the exemplary embodiments of the present disclosure, since the transaction and the header information are recorded in different tables and are managed by the DBMS, a data input/output speed and a data lookup speed may be improved. Hereinafter, a blockchain network system according to exemplary embodiments of the present disclosure will be described with reference to FIG. 1.

FIG. 1 is a schematic diagram illustrating a blockchain network system according to exemplary embodiments of the present disclosure.

In the exemplary embodiments of the present disclosure, a blockchain network 10 may mean a plurality of nodes operating based on blockchain technology. Herein, the blockchain technology is distributive storage technology which stores data to be managed in the plurality of nodes included in the blockchain network by using a storage structure in which blocks are connected in the form of a chain.

Referring to FIG. 1, the blockchain network 10 may include the plurality of nodes 100a, 100b, . . . , and 100. Each of the plurality of nodes 100 included in the blockchain network 10 may communicate with a different node through a communication network.

Each of the plurality of nodes 100 included in the blockchain network 10 may be implemented with one of a Personal Computer (PC), a desktop computer, a lap-top computer, a table PC, a server, and a mobile computing device. Herein, the mobile computing device may be implemented with a mobile phone, a smart phone, an Enterprise Digital Assistant (EDA), a digital still camera, a digital video camera, a Portable Multimedia Player (PMP), a Personal Navigation Device or Portable Navigation Device (PND), a Mobile Internet Device (MID), a wearable computer, an Internet of Things (IoT) device, or an Internet of Everything (IoE) device. However, the node is not limited thereto, and any kind of terminal which is capable of accessing a wired/wireless network may be each of the plurality of nodes 100.

Each of the plurality of nodes 100 may be a predetermined entity which is capable of processing and storing a transaction that is predetermined data. That is, each of the plurality of nodes 100 may operate as a node configuring the blockchain network 10.

In the present disclosure, the blockchain network 10 may be a private blockchain network. However, the present disclosure is not limited thereto.

In the meantime, according to the exemplary embodiments of the present disclosure, the blockchain network 10 may be divided into a predetermined number of block manager nodes and general nodes. Herein, the general node may mean a node except for the block manager node among the plurality of nodes configuring the blockchain network 10. In the meantime, the block manager node may mean the predetermined node that can be trusted by the blockchain network 10. In the present disclosure, the general node may perform a function of issuing a transaction and generating header information for the transaction. Further, the block manager node may perform a function of calculating a hash value of current header information to be recorded in header information related to the transaction issued from each of the plurality of nodes 100 and a hash value of previous header information and transmitting the calculated hash values to the plurality of nodes 100, as well as the same function as that of the general node.

According to other exemplary embodiments of the present disclosure, each of the plurality of nodes configuring the blockchain network 10 may also be the sequential block manager node according to a predetermined rule.

In particular, in the predetermined rule, information on a logical order in which each of the plurality of nodes becomes the block manager node is recorded. That is, in the case where a specific node becomes the block manager node at a first time point, information on which node becomes the block manager node after the first time point may be recorded in the predetermined rule. Further, each of the plurality of nodes may store the predetermined rule in a storage unit. Accordingly, each of the plurality of nodes may check which node is currently the block manager node and then recognize a node that will become the next block manager node based on the predetermined rule.

In the meantime, the plurality of nodes 100 configuring the blockchain network in the present disclosure may progress consensus in a following method.

In particular, the block manager node may recognize an order of the header information according to a predetermined protocol and determine a hash value of current header information to be recorded in the header information and a hash value of previous header information. Further, the block manager node may transmit the hash value of the current header information and the hash value of the previous header information to the plurality of nodes configuring the blockchain network 10. In this case, each of the plurality of nodes may check whether the received hash value of the current header information and the received hash value of the previous header information are determined according to the predetermined protocol. When the predetermined number of nodes (for example, the majority of all nodes) among the plurality of nodes recognize that the hash value of the current header information and the hash value of the previous header information are determined according to the predetermined protocol, each of the plurality of nodes may recognize that the consensus is completed. In this case, each of the plurality of nodes may record the hash value of the current header information and the hash value of the previous header information in a header table of each node. However, when only nodes less than the predetermined number among the plurality of nodes recognize that the hash value of the current header information and the hash value of the previous header information are determined according to the predetermined protocol, each of the plurality of nodes may recognize that the consensus is not completed. Further, the block manager node may check the order of the header information based on the predetermined protocol again, and then determine the hash value of the current header information and the hash value of the previous header information. However, the present disclosure is not limited thereto.

In the meantime, the header information in the present disclosure may mean information recorded in the block header in the general blockchain network.

In the present disclosure, the header information may include a time stamp indicating a generation time of the header information, generation node information about the node generating the header information, identification information for identifying the header information, an identifier indicating whether a commit of the header information is completed, and the hash value of the previous header information, and the hash value of the current header information. However, the present disclosure is not thereto, and the header information may include more or fewer constituent elements than the constituent elements listed above.

According to the exemplary embodiments of the present disclosure, in the case where any one transaction occurs, any one node 100a configuring the blockchain network may record at least one transaction in a transaction table stored in a storage unit thereof. Herein, the transaction is the same as the transaction that is the term used in the general blockchain network, and a transaction detail and the like may be the transaction. Further, the transaction table may mean the recording of the transaction in the storage unit in the form of a table used in the DBMS system.

In the case where the transaction occurs and is recorded in the transaction table stored in the storage unit of the node 100a, the node 100a may generate header information for at least one transaction and record the generated header information in the header table. Herein, the header information may mean information recorded in a header of the block of the general blockchain network. Further, the header table may mean the recording of the header information in the storage unit in the form of a table used in the DBMS system.

The node 100a may record the header information in the header table, and then transmit the header information or a signal including at least one transaction related to the header information to at least one node included in the blockchain network. In this case, at least one node receiving the signal may record the header information included in the signal in the header table of the node 100a, and record at least one transaction included in the signal in a body table of the node 100a. Further, at least one node receiving the signal may propagate the signal to all of the nodes included in the blockchain network. Accordingly, all of the nodes configuring the blockchain network may cause the same header information and transaction to be recorded in the header tables and the body tables thereof.

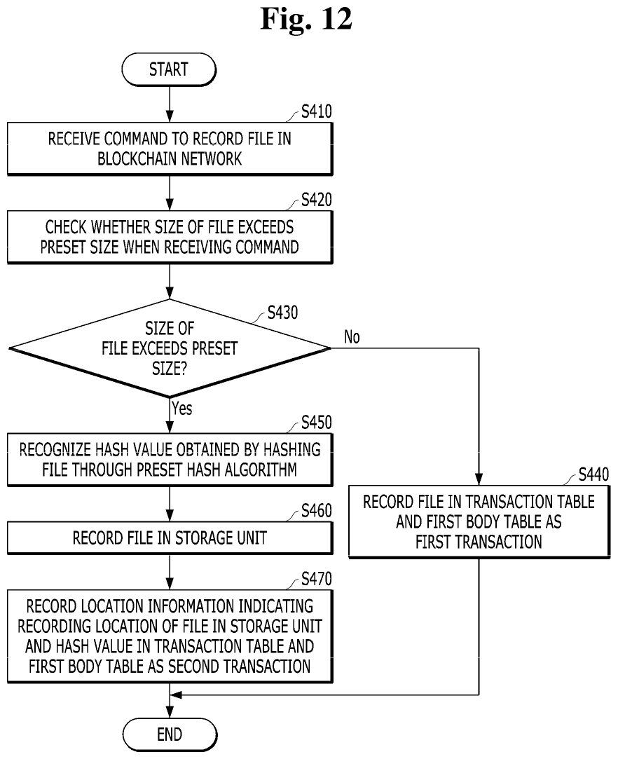

In the meantime, according to the exemplary embodiments of the present disclosure, when the node 100 included in the blockchain network 10 receives a command to record the file in the blockchain network, the node 100 may check whether a size of the file exceeds a preset size. Further, the node 100 included in the blockchain network 10 may determine a method of recording a second transaction including the file in the transaction table and the body table based on whether the size of the file exceeds the preset size. This will be described in detail below with reference to FIG. 12.

FIG. 2 is a block diagram illustrating the nodes configuring the blockchain network system according to exemplary embodiments of the present disclosure.

The node 100 which will be described below with reference to FIG. 2 may mean any one node among the plurality of nodes configuring the blockchain network. That is, the node 100 to be described with reference to FIG. 2 is not limited to a specific node, and a block manager node, a general node, and the like may be the node 100 to be described with reference to FIG. 2.

Referring to FIG. 2, the node 100 may include a communication unit 110, a storage unit 120, and a processor 130. However, the foregoing constituent elements are not essential in implementing the node 100, so that the node 100 may include more or fewer constituent elements than the constituent elements listed above. Herein, each of the constituent elements may be formed of a separate chip, module, or a device, and may also be included in one device.

The communication unit 110 may include a wired/wireless Internet module for network access. As wireless Internet technology, a Wireless LAN (WLAN) (Wi-Fi), a Wireless broadband (Wibro), World Interoperability for Microwave Access (Wimax), High Speed Downlink Packet Access (HSDPA), and the like may be used. As wired Internet technology, Digital Subscriber Line (XDSL), Fibers to the Home (FTTH), Power Line Communication (PLC), and the like may be used. Further, the communication unit 110 may include a short range communication module. As short range communication technology, Bluetooth, Radio Frequency Identification (RFID), Infrared Data Association (IrDA), Ultra Wideband (UWB), ZigBee, and the like may be used.

The storage unit 120 may store the predetermined form of information generated or determined by the processor 130 or predetermined form of information received by the communication unit 110.

The storage unit 120 may include a memory and/or a persistent storage medium. The memory may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk.

According to the exemplary embodiments of the present disclosure, the storage unit 120 may store the header table, the body table, and the transaction table. Herein, the header table may mean the recording of the header information in the storage unit 120 in the form of a table used in the DBMS system. Further, the transaction table may mean the recording of the transaction in the storage unit 120 in the form of a table used in the DBMS system. In the meantime, the body table may mean the recording of the transaction in the storage unit 120 in the form of a table used to share between the plurality of nodes 100a, 100b, . . . , and 100 included in the blockchain network 10. That is, the transaction of each of the plurality of nodes included in the blockchain network 10 may be recorded in the body table in the form of the table. Herein, the body table may have the same row as that of the transaction table. However, the present disclosure is not limited thereto.

The processor 130 may generally process the general operation of the node 100. The processor 130 may provide a user with appropriate information or function or process appropriate information or function by processing a signal, data, information, and the like input or output through the constituent elements or driving an application program stored in the storage unit 120.

The processor 130 may be formed of one or more cores, and may include a predetermined type of processor, such as a central processing unit (CPU), a general purpose graphics processing unit (GPGPU), and a tensor processing unit (TPU) of the node 100, for executing commands stored in the storage unit 120. The processor 130 may read a computer program stored in the storage unit 120 and perform operations according to the exemplary embodiments of the present disclosure.

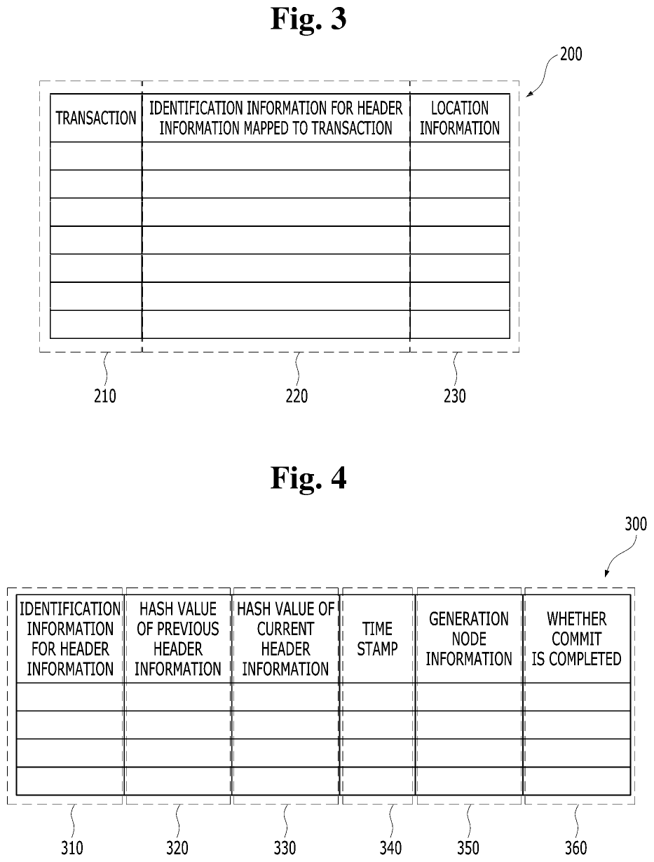

FIG. 3 is a diagram for describing the transaction table recorded in the storage unit of each of a plurality of nodes included in the blockchain network according to exemplary embodiments of the present disclosure.

Referring to FIG. 3, the transaction table 200 may include a first transaction table column 210, a second transaction table column 220, and a third transaction table column 230. However, the present disclosure is not limited thereto, and the transaction table 200 may also include more transaction table columns than the foregoing transaction table columns.

The first transaction table column 210 may be the column in which at least one transaction is recorded. Herein, the transaction may be recorded in the form of a plain text in the transaction table column 210. However, the present disclosure is not limited thereto.

The second transaction table column 220 may be the column in which identification information for header information mapped to each of at least one transaction recorded in each transaction table row of the transaction table is recorded. Herein, the transaction table row may mean each row existing in the transaction table. In the meantime, the identification information will be described in detail with reference to FIG. 4.

In the case where the second transaction including the file is recorded in the first transaction table column 210, the third transaction table column 230 may be the column in which location information indicating a location at which the file is recorded in the storage unit of the node is recorded. Herein, the location at which the file is recorded in the storage unit of the node may mean an access path to access the file. For example, the location information may be expressed in the form, such as “C:\block” (that is, a Block folder of C drive).

In the meantime, according to the exemplary embodiments of the present disclosure, in the case where the transaction including no file is recorded in the first transaction table column 210, a null value may be recorded in the third transaction table column 230. However, the present disclosure is not limited thereto.

According to the exemplary embodiments of the present disclosure, each of the plurality of nodes 100 included in the blockchain network 10 may communicate with another node through the communication network.

In particular, the plurality of nodes 100 included in the blockchain network 10 may share the transaction occurring in the plurality of nodes 100. Further, the plurality of nodes 100 may be recorded in the body table having the same form as that of the transaction table 200 illustrated in FIG. 3.

For example, in the case where the first transaction occurs in the first node and the second transaction occurs in the second node, the first transaction may be recorded in the transaction table of the first node and the first transaction and the second transaction may be recorded in the body table of the first node. Further, the second transaction may be recorded in the transaction table of the second node and the second transaction and the first transaction may be recorded in the body table of the second node. However, the present disclosure is not limited thereto.

FIG. 4 is a diagram for describing the header table recorded in the storage unit of each of a plurality of nodes included in the blockchain network according to exemplary embodiments of the present disclosure.

Referring to FIG. 4, the header table 300 may include a first header table column 310, a second header table column 320, a third header table column 330, a fourth header table column 340, a fifth header table column 350, and a sixth header table column 360. However, the present disclosure is not limited thereto, and the header table 300 may include more or fewer header table columns than the foregoing header table columns.

The first header table column 310 may be the column in which the identification information for the header information is recorded. Herein, the identification information may mean a number, text, or the like assigned to each header information so as to identify each header information.

The second header table column 320 may be the column in which the hash value of the previous header information is recorded. Herein, the previous header information may mean header information having an order earlier than the order of the corresponding header information. More particularly, the previous header information may mean header information that is one earlier order than the corresponding header information.

For example, in the case where the first header information and the second header information are recorded in the header table and the second header information is one earlier order than the first header information, the value recorded in the hash value of the current header information of the second header information may be the hash value of the previous header information of the first header information.

The third header table column 330 may be the column in which the hash value of the current header information is recorded. Herein, the hash value of the current header information may be the value obtained by hashing at least one transaction related to the corresponding header information based on a hash algorithm.

The fourth header table column 340 may be the column in which time information at which the header information is generated, that is, a time stamp generating the header information is recorded.

According to the exemplary embodiments of the present disclosure, the time information at which the header information is generated may be recorded as a time stamp that is logical time data in the fourth header table column 340.

The fifth header table column 350 may be the column in which information about the node generating the header information is recorded.

For example, a number, or text, or the like assigned to the node generating the header information so as to identify the node generating the header information may be recorded in the fifth header table column 350.

The sixth header table column 360 may be the column in which an indicator indicating whether a commit of the header information is completed is recorded. For example, in the case where “Y” is recorded in the sixth header table column 360 of the row in which the header information is recorded, it may be recognized that the commit of the corresponding header information is completed. Further, in the case where “N” s recorded in the sixth header table column 360 of the row in which the header information is recorded, it may be recognized that the commit of the corresponding header information is not completed. As described above, in the case where the indicator indicating whether the commit of each header information is completed is recorded in the header table 300, a processing speed for the processor 130 to find the uncommitted header information may be increased.

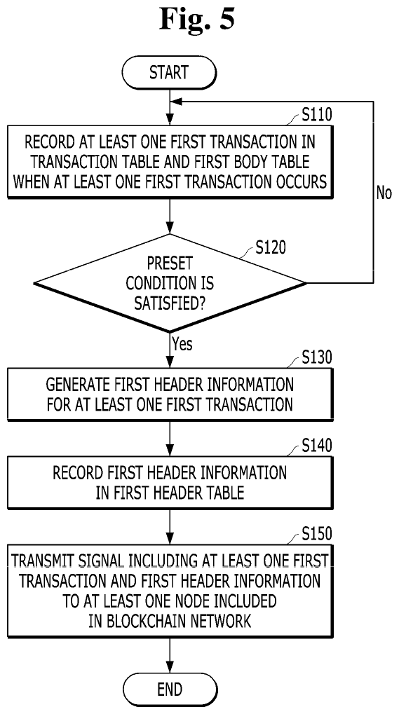

Hereinafter, an example of a method of recording a transaction in the transaction table and the body table and recording header information in the header table by the node 100 will be described with reference to FIGS. 5 to 8.

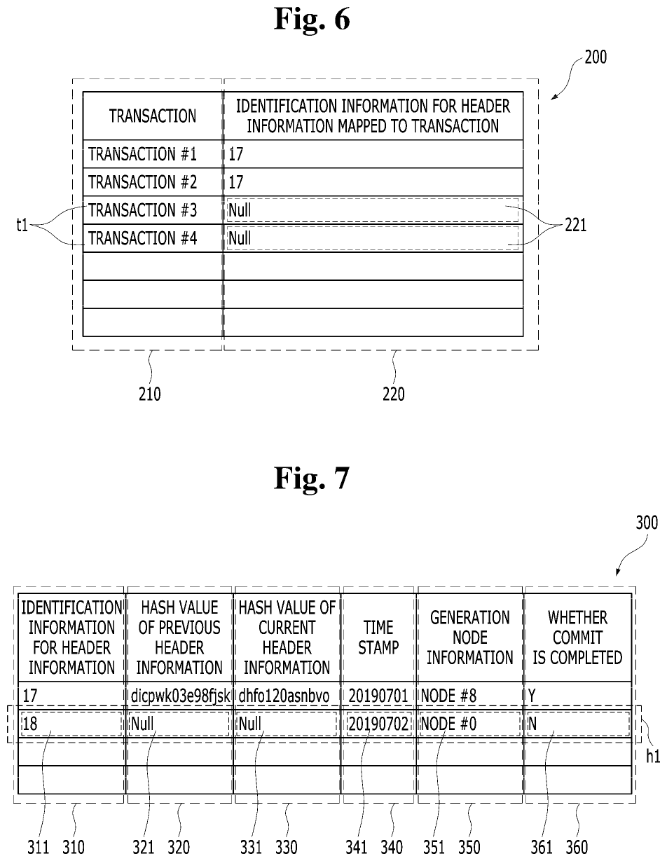

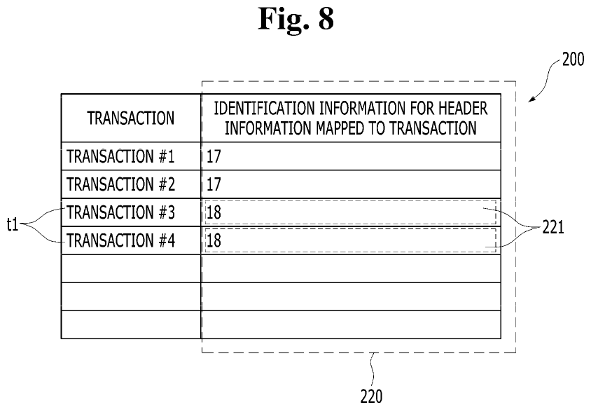

FIG. 5 is a flowchart for describing an example of a method of recording a transaction in the transaction table and recording header information in the header table by the node according to exemplary embodiments of the present disclosure. FIGS. 6 to 8 are diagrams for describing an example of a method of recording a transaction in the transaction table and recording header information in the header table by the node according to exemplary embodiments of the present disclosure. In relation to FIGS. 5 to 8, contents overlapping those described with reference to FIGS. 1 to 4 will not be described again, and a difference will be mainly described below. Further, FIGS. 5 to 8 do not describe that a transaction including a file is recorded in the transaction table, so that the third transaction table column is not illustrated in FIGS. 6 and 8.

Referring to FIG. 5, when at least one first transaction occurs, the processor 130 may record at least one first transaction in the transaction table (S110). Herein, the transaction table may be already stored in the storage unit 120 of the node 100.

In particular, referring to FIG. 6, when at least one first transaction t1 occurs, the processor 130 may record at least one first transaction t1 in the first transaction table column 210 of the transaction table. Further, the processor 130 may record a null value in at least one data cell 221 corresponding to a transaction table row in which at least one first transaction is recorded and the second transaction table column. That is, the processor 130 may record the null value in the data cell 221 in which the transaction table row, in which at least one first transaction is recorded, is located in the second transaction table column.

For example, when two transactions t1 occur, the processor 130 of the node 100 may record the two transactions t1 in the first transaction table column 210. In the meantime, the processor 130 of the node 100 may record the null values in two data cells 221 corresponding to the transaction table row in which the two transactions t1 are recorded and the second transaction table column 220, respectively. That is, the processor 130 of the node 100 may record the null values in the two data cells 221 in which the transaction table row, in which the two transactions t1 are recorded, is located in the second transaction table column 220, respectively.

In the meantime, in connection with the record of the first transaction t1 in the transaction table, the node 100 may record the first transaction t1 in the first body table. Herein, the first body table may include the same column as that of the transaction table. However, the present disclosure is not limited thereto.

Referring back to FIG. 5, the processor 130 may recognize whether a preset condition is satisfied (S120). Herein, the preset condition may be satisfied according to a preset time interval, or may be satisfied in the case where the number of at least one first transaction recorded in the transaction table exceeds a preset number.

For example, when a preset time lapses after the processor 130 recognizes that the preset condition is satisfied at a first time point, the processor 130 may recognize that the preset condition is satisfied again.

To give another example, when the number of transactions having the null values in the second transaction table column among the transactions recorded in the transaction table exceeds a preset number, the processor 130 may also recognize that the preset condition is satisfied.

However, the case where the preset condition is satisfied is not limited to the example.

When the present condition is not satisfied (S120, NO), the processor 130 may stand by until the preset condition is satisfied. In this case, when an additional transaction occurs before the preset condition is satisfied, the processor 130 may also record the additionally occurring transaction in each of the transaction table and the body table.

In the meantime, when the preset condition is satisfied (S120, YES), the processor 130 may generate first header information for at least one first transaction (S130). Herein, the first header information may include at least one of a time stamp indicating a time when the first header information is generated, generation node information for a node generating the first header information, first identification information for identifying the first header information, a hash value of previous header information, a hash value of current header information, or an identifier indicating whether a commit is completed.

When the first header information is generated in operation S130, the processor 130 may record the first header information in the first header table (S140). Herein, the first header table may be already stored in the storage unit 120 of the node 100.

In particular, referring to FIG. 7, when the first header information h1 is generated, the processor 130 may record the first header information in the first header table 300.

More particularly, the processor 130 may calculate identification information of the first header information h1 when generating the first header information h1. Further, the processor 130 may record the identification information (for example, “18”) of the first header information h1 in a data cell 311 corresponding to in the header table row in which the first header information h1 is to be recorded and the first header table column 310. That is, the processor 130 may record “18” that is the identification information of the first header information h1 in the data cell 311 in which the header table row in which the first header information h1 is to be recorded is located in the first header table column 310.

In the meantime, since the first header information h1 is not the header information committed by a consensus algorithm, the hash value of the previous header information and the hash value of the current header information may not be included in the first header information h1. Accordingly, the processor 130 may record the null value in the second data cell 321 corresponding to the header table row in which the first header information h1 is to be recorded and the second header table column 320. Further, the processor 130 may also record the null value in a third data cell 331 corresponding to the header table row in which the first header information h1 is to be recorded and the third header table column 330. That is, the processor 130 may record the null value in the second data cell 321 in which the header table row in which the first header information is to be recorded is located in the second header table column 320, and may also record the null value in the third data cell 331 that is the header table row in which the first header information is to be recorded in the third header table column 330.

The processor 130 may generate a time stamp indicating a logical time at which the first header information h1 is generated when generating the first header information h1. Then, the processor 130 may record the time stamp in a data cell 341 corresponding to the header table row in which the first header information h1 is to be recorded and the fourth header table column 340.

In the present disclosure, each of the plurality of nodes 100 configuring the blockchain network 10 may have identification information based on which the node itself is distinguished from other nodes. Accordingly, the processor 130 may recognize information for the generation node that generates the first header information h1, that is, the identification information based on which the generation node can be distinguished from other nodes, when generating the first header information h1. Herein, the information for the generation node may mean the information that can identify the node generating the first header information h1. Then, the processor 130 may record the identification information in a data cell 351 corresponding to the header table row in which the first header information h1 is to be recorded and the fifth header table column 351. That is, the processor 130 may record the identification information in the data cell 351 in which the header table row in which the first header information h1 is to be recorded is located in the fifth header table column 350.

Since the commit of the first header information is not completed through the consensus algorithm when the processor 130 generates the first header information h1, the processor 130 may generate an identifier (for example, “N”) indicating that the commit of the first header information h1 is not completed. Then, the processor 130 may record the generated identifier in a data cell 361 corresponding to the header table row in which the first header information h1 is to be recorded and the sixth header table column 360. That is, the processor 130 may record the generated identifier in the data cell 361 in which the header table row in which the first header information h1 is to be recorded is located in the sixth header table column 360.

In the meantime, according to the exemplary embodiments of the present disclosure, the processor 130 may map the first header information to at least one first transaction when the first header information is recorded in the header table in operation S140 of FIG. 5.

In particular, referring to FIG. 8, when the first header information is recorded in the header table, the processor 130 may record the first identification information in at least one first data cell 221 corresponding to a least one first transaction table row in which at least one first transaction t1 used when the first header information is generated is recorded and the second transaction table column 220 in the transaction table 200. That is, the processor 130 may record the first identification information in the first data cell 221 in which at least one first transaction table row is located in the second transaction table column 220.

For example, when “18” that is the first identification information of the first header information is recorded in the data cell 311 of the header table 300 of FIG. 7, the processor 130 may record “18” in the first data cell 221 within the transaction table 200 of FIG. 8 as the first identification information.

As described above, when at least one first transaction t1 is mapped with the first header information h1, the information recorded in the transaction table and the header table may be associated with each other.

In the meantime, referring back to FIG. 5, when the processor 130 records the first header information in the first header table in operation S140, the processor 130 may transmit a signal including at least one first transaction and the first header information to at least one node included in the blockchain network (S150).

In particular, the processor 130 may transmit a signal including at least one first transaction and the first header information to at least one node included in the blockchain network 10 so that one or more first transactions are recorded in the second body tables of the plurality of nodes included in the blockchain network 10, respectively, and the first header information is recorded in the second header tables of each of the plurality of nodes included in the blockchain network.

In this case, at least one node may record the first header information in the second header table stored in the storage unit of the node, and record at least one transaction in the second body table stored in the storage unit of the node. Further, at least one node may propagate the signal to all of the nodes configuring the blockchain network 10. Accordingly, all of the nodes configuring the blockchain network may record the same information in the body tables and the header tables.

In the meantime, according to the present disclosure, when the processor 130 transmits the signal to at least one node in operation S150, the processor 130 may perform an electronic signature on the signal based on a Public Key Infrastructure (PKI) encryption algorithm and transmit the signal to at least one node. In this case, at least one node may verify the electronic signature of the signal and only when the verification is completed, at least one node may store the first header information and at least one first transaction included in the signal in the storage unit of the node. However, the present disclosure is not limited thereto.

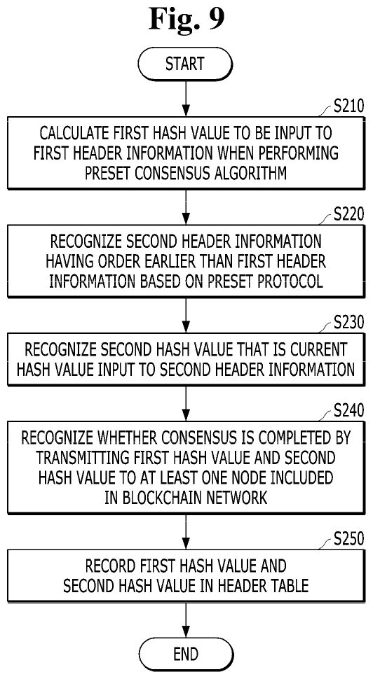

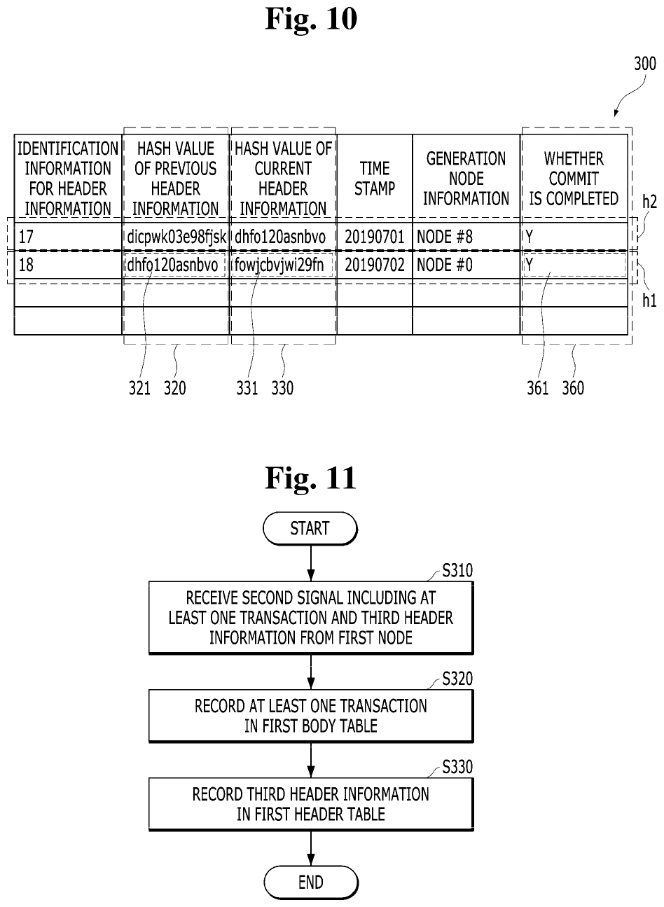

FIG. 9 is a flowchart for describing an example of a method of committing the header information recorded in the header table based on the preset consensus algorithm according to exemplary embodiments of the present disclosure. FIG. 10 is a diagram for describing an example of the method of committing the header information recorded in the header table based on the preset consensus algorithm according to exemplary embodiments of the present disclosure. In relation to FIGS. 9 and 10, contents overlapping those described with reference to FIGS. 1 to 8 will not be described again, and a difference will be mainly described below.

First, according to the exemplary embodiments of the present disclosure, when at least one first transaction occurs, the processor 130 of the node may record at least one first transaction in the transaction table. Then, when the preset condition is satisfied, the processor 130 may generate first header information for at least one first transaction and record the first header information in the header table. In the meantime, the processor 130 may commit the first header information based on the preset consensus algorithm. Herein, for convenience of the description, the present disclosure will be described on an assumption that the node is the block manager node.

In particular, referring to FIG. 9, when the processor 130 performs the preset consensus algorithm, the processor 130 may calculate a first hash value that is a hash value of current header information to be input to the first header information (S210). Herein, the first header information may mean the uncommitted header information, that is, the header information in which the null value is input to the hash value of the current header information and the hash value of the previous header information. Further, the first hash value may mean a value obtained by hashing at least one first transaction related to the first header information by using a preset hash algorithm. Herein, as the preset hash algorithm, hash functions, such as Message-Digest (MD)1, MD4, MD5, Secure Hash Standard (SHS), Secure Hash Algorithm (SHA)-256, SHA-512, Hash Algorithm Standard (HAS)-160, Hashing Algorithm with Variable Length (HAVAL) of output, and RACE Integrity Primitives Evaluation Message Digest (RIPEMD)-160, may be used. Further, the preset hash algorithm may be stored in the storage units of all of the nodes configuring the blockchain network.

When the preset consensus condition is satisfied in operation S210, the processor 130 may check whether the first header information that is the uncommitted header information recorded in the header table is recorded in the header table of each of the plurality of nodes included in the blockchain network. Further, when the processor 130 recognizes that the first header information that is the uncommitted header information is recorded in the header table of each of the plurality of nodes included in the blockchain network, the processor 130 may calculate the first hash value. Herein, the preset consensus condition may be satisfied according to a preset time interval, or may be satisfied in the case where the number of uncommitted header information existing in the header table of the block manager node exceeds a preset number.

More particularly, the processor 130 may control the communication unit 110 to transmit a first signal for checking whether the first header information that is the uncommitted header information is recorded in the second header table of each of the plurality of nodes to each of the plurality of nodes. Then, the processor 130 may check whether the first header information that is the uncommitted header information is recorded in the header table of each of the plurality of nodes included in the blockchain network based on a second signal received from the plurality of nodes in response to the first signal. Herein, the second signal may include node identification information about the node transmitting the second signal and an identifier indicating whether the uncommitted header information is recorded in the header table. Further, when the processor 130 recognizes that the first header information that is the uncommitted header information is recorded in the header table of each of the plurality of nodes included in the blockchain network, the processor 130 may calculate the first hash value.

For example, when the second signal received from the first node among the plurality of nodes includes a first identifier indicating that “the first header information is not recorded in the header table of the first node”, the processor 130 may recognize that the first header information is not recorded in the header table of the first node. In this case, the processor 130 may recognize the first node in which the first header information is not recorded in the header table based on the node identification information included in the second signal. Then, the processor 130 may control the communication unit 110 so as to transmit the first header information and at least one first transaction related to the first header information to the first node.

In the meantime, when the second signal received from the plurality of nodes includes a second identifier indicating that “the first header information is recorded in the second header table of the plurality of nodes configuring the blockchain network”, the processor 130 may recognize that the first header information is recorded in the second header table of the plurality of nodes. That is, the processor 130 may analyze the identifier included in the second signal and recognize whether the first header information that is the uncommitted header information is recorded in the node transmitting the second signal. Then, when the processor 130 recognizes that the first header information is recorded in the header table of the plurality of nodes included in the blockchain network, the processor 130 may calculate the first hash value.

In the meantime, the processor 130 may recognize the first identification information recorded in the first header information when calculating the first hash value of the first header information. The processor 130 may search at least one first transaction related to the first header information in the transaction table by using the first identification information. Then, the processor 130 may hash at least one first transaction by using the preset hash algorithm in order to calculate the first hash value.

For example, referring back to FIG. 7, the processor 130 may recognize “18” that is the first identification information based on which the uncommitted first header information h1 can be identified in the header table 300 in the first header table column 310. Further, referring to FIG. 8, the processor 130 may recognize the two first transactions t1 having the first identification information of “18” in the transaction table 200 through the search. Then, the processor 130 may calculate the first hash value by randomly combining the two first transactions (transaction #3 and transaction #4) having the first identification information of “18” and hashing the combination by using the preset hash algorithm.

In the meantime, the processor 130 may recognize the second header information having an order earlier than the first header information, that is, the second header information of one order earlier than the first header information based on a preset protocol (S220). Herein, in the preset protocol, rules that determine which header information is in the earlier order may be defined, and the preset protocol may be stored in the storage unit of each of the plurality of nodes configuring the blockchain network.

When the processor 130 recognizes the second header information having the order earlier than the first header information in operation S220, the processor 130 may recognize a second hash value that is the current hash value input to the second header information (S230). Herein, the second hash value that is the current hash value input to the second header information may mean the value obtained by hashing at least one first transaction related to the second header information by using the preset hash algorithm.

In the meantime, when the processor 130 recognizes the first hash value and the second hash value in operations S210 and S230, the processor 130 may recognize whether the consensus is completed by transmitting the first hash value and the second hash value to at least one node included in the blockchain network 10 (S240).

In particular, the processor 130 may receive a third signal indicating whether the first hash value and the second hash value are determined according to the preset protocol from the plurality of nodes included in the blockchain network 10 after transmitting the first hash value and the second hash value to at least one node included in the blockchain network 10. Then, the processor 130 may check whether the predetermined number of nodes recognizes that the first hash value and the second hash value are determined according to the preset protocol based on the third signal. Then, when the predetermined number of nodes recognizes that the first hash value and the second hash value are determined according to the preset protocol, the processor 130 may recognize that the consensus is completed.

When it is recognized that the consensus is completed in operation S240, the processor 130 may record the first hash value and the second hash value in the header table (S250).

In particular, referring to FIG. 10, the processor 130 may record the first hash value (fowjcbvjwi29fn) obtained by hashing at least one transaction t1 of FIG. 7 related to the first header information h1 through the preset hash algorithm in the third data cell 331. Further, the processor 130 may recognize the second hash value (dhfo120asnbvo) that is the hash value of the current header information input to the second header information h2 having the order earlier than the first header information h1, and record the second hash value in the second data cell 321.

In the meantime, when the first hash value and the second hash value are recorded in the first header information h1, the processor 130 may record the identifier (for example, “Y”) indicating that the commit is completed in the data cell 361 corresponding to the header table row in which the first header information h1 is recorded in the sixth header table column 360.

In the meantime, according to the exemplary embodiments of the present disclosure, the processor 130 may transmit the first hash value and the second hash value to the plurality of nodes so that the first hash value and the second hash value are recorded in the header table of each of the plurality of nodes after the first hash value and the second hash value are recorded in the header table in operation S250. In this case, when each of the plurality of nodes verifies validity of the first hash value and the second hash value and then recognizes that the first hash value and the second hash value are valid, each of the plurality of nodes may record the first hash value and the second hash value in the header table.

When all of the header information recorded in the header table are connected in the form of the chain of the blockchain technology through the hash values as described above, it is difficult for any subject including the node configuring the blockchain network 10 to change the header information and the transaction, and easily recognize the changed contents when the header information and the transaction are changed. That is, it is difficult to change the transaction related to the committed header information and the committed transaction, reliability for the information recorded in the transaction table and the header table may be secured.

In the meantime, according to the exemplary embodiments of the present disclosure, the node may also receive a signal including at least one transaction and third header information from another node. This will be described in detail with reference to FIG. 11 below.

FIG. 11 is a flowchart for describing an example of a method of recording at least one transaction and header information in the case where the node receives a signal including at least one transaction and header information from another node according to exemplary embodiments of the present disclosure. In relation to FIG. 11, contents overlapping those described with reference to FIGS. 1 to 8 will not be described again, and a difference will be mainly described below.

Referring to FIG. 11, the processor 130 may receive a signal including at least one transaction and third header information related to at least one transaction from any one node among the plurality of nodes configuring the blockchain network (S310). Herein, the third header information is the uncommitted header information and may include at least one of a time stamp indicating a time at which the third header information is generated, generation node information about the node generating the third header information, and second identification information for identifying the third header information. Operation S310 may be the same as the case where the transaction and the header information are generated and transmitted by anther node as described with reference to FIG. 5.

The processor 130 may record at least one transaction in the transaction table according to the reception of the second signal (S320). Herein, the processor 130 may map the second header information to at least one transaction when recording at least one transaction in the transaction table. This has been described in detail with reference to FIGS. 5 to 8, so that the detailed description thereof will be omitted.

In the meantime, the processor 130 may record third header information in the header table according to the reception of the second signal (S330). Herein, the header table may include a first header table column in which the second identification information is recorded, a second header table column in which the hash value of the previous header information is recorded, and a third header table column in which the hash value of the current header information is recorded. Further, the processor 130 may record a null value in a fourth data cell corresponding to the second header table column and the second header table row in which the third header information is recorded when recording the third header information in the header table. Further, the processor 130 may record a null value in a fifth data cell corresponding to the third header table column and the second header table row in which the third header information is recorded. This has been described in detail with reference to FIGS. 5 to 8, so that the detailed description thereof will be omitted.

In FIG. 11, since the node also records the transaction generated in another node and the header information related to the corresponding transaction in the transaction table and the header table as described above, all of the plurality of nodes configuring the blockchain network may have the same information in the transaction tables and the header tables.

As described above, according to the exemplary embodiments of the present disclosure, the transaction and the header information related to the transaction are recorded in the form of the table of the DBMS system, a data input/output speed and a data lookup speed may be improved.

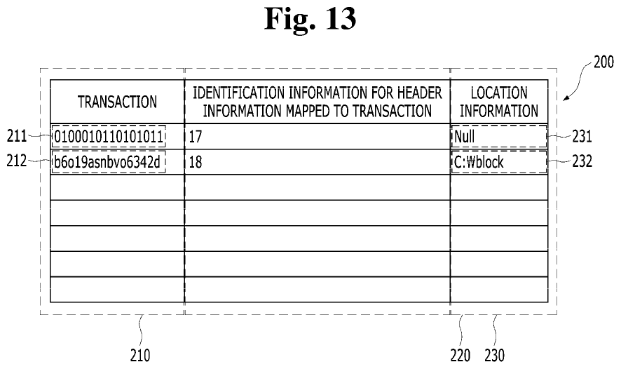

FIG. 12 is a flowchart for describing an example of a method of recording, by the node, a transaction including a file in the blockchain network according to exemplary embodiments of the present disclosure. FIG. 13 is a diagram for describing an example of a method of recording, by the node, a transaction including a file in the blockchain network according to exemplary embodiments of the present disclosure. In relation to FIGS. 12 and 13, contents overlapping those described with reference to FIGS. 1 to 8 will not be described again, and a difference will be mainly described below.

Referring to FIG. 12, the processor 130 may receive a command to record the file in the blockchain network 10 (S410). When the processor 130 receives the command, the processor 130 may check whether a size of the file exceeds a preset size (S420).

According to the exemplary embodiments of the present disclosure, the processor 130 may determine a method of recording the file in the transaction table and the body table based on whether the size of the file exceeds the preset size.

In particular, when the size of the file does not exceed the preset size (S430), the processor 130 may record the file in the transaction table and the first body table as a first transaction (S440). Herein, each of the transaction table and the body table may include a first transaction table column in which a hash value of a file and the file are recorded, a second transaction table column in which identification information for the header information mapped to each of at least one transaction recorded in each transaction table row is recorded, and a third transaction table column in which location information indicating a location at which the file is recorded in the storage unit of the node is recorded. The table has been described in detail with reference to FIGS. 3 and 4, so that the detailed description thereof will be omitted.

More particularly, as illustrated in FIG. 13, when the size of the file does not exceed the preset size, the processor 130 may record data (for example, 0100010110101011) obtained by expressing the file in the binary format in the first data cell 211 of the first transaction table column 210. Further, the processor 130 may record a null value in the second data cell 231 of the third transaction table column 230 located in the same row as that of the first data cell 211. That is, since the file is recorded in the first data cell 211 in the binary format, the location at which the file is stored in the second data cell 231 may not be separately recorded.

Referring back to FIG. 12, when the size of the file exceeds the preset size (S430, YES), the processor 130 may recognize a hash value obtained by hashing the file through the preset hash algorithm. Further, the processor 130 may record the file in the storage unit. Then, the processor 130 may record the location information indicating the location in which the file is stored in the storage unit and the hash value in the transaction table and the first body table as a second transaction.

In particular, when the size of the file exceeds the preset size, the processor 130 may record a hash value in the third data cell of the first transaction table column. Further, the processor 130 may record the location information in a fourth data cell of the third transaction table column located in the same row as that of the first data cell.

More particularly, as illustrated in FIG. 13, when the size of the file exceeds the preset size, the processor 130 may record the hash value (for example, b6o19asnbvo6342d) of the file in the third data cell 212 of the first transaction table column 210. Then, the processor 130 may record the location information indicating the location at which the file is stored in the fourth data cell 232 of the third transaction table column 230 located in the same row as that of the first data cell 212.

Herein, the processor 130 may check the setting for the share of the file before recording the location information in the fourth data cell 232. Then, the processor 130 may determine to record the location information in the fourth data cell 232 according to the setting.

In particular, when a first setting indicating the file is shared is set, the processor 130 may record the location information indicating the location at which the file is stored in the storage unit in the fourth data cell 232.

In the meantime, when a second setting indicating that the file is not shared is set, the processor 130 may determine not to record the location information indicating the location at which the file is stored in the storage unit in the fourth data cell 232. That is, the processor 130 may record the null value in the fourth data cell 232 instead of the location information.

Referring back to FIG. 12, when the preset condition is satisfied after the second transaction is recorded in the transaction table and the body table, the processor 130 may generate the second header information for the second transaction. The processor 130 may record the second header information in the header table. Then, when the processor 130 records the second header information in the header table, the processor 130 may transmit the second transaction and the second header information to at least one node included in the blockchain network 10.

Herein, the processor 130 may check the setting for the share of the file when transmitting the second transaction and the second header information to at least one node included in the blockchain network 10. Then, the processor 130 may determine whether to transmit the file to at least one node included in the blockchain network 10 together with the second transaction and the header information according to the setting.

In particular, when the first setting indicating that the file is shared is set, the processor 130 may transmit the file to at least one node included in the blockchain network 10 together with the second transaction and the second header information.

In the meantime, when the second setting indicating that the file is not shared is set, the processor 130 may determine not to transmit the file to at least one node included in the blockchain network 10.

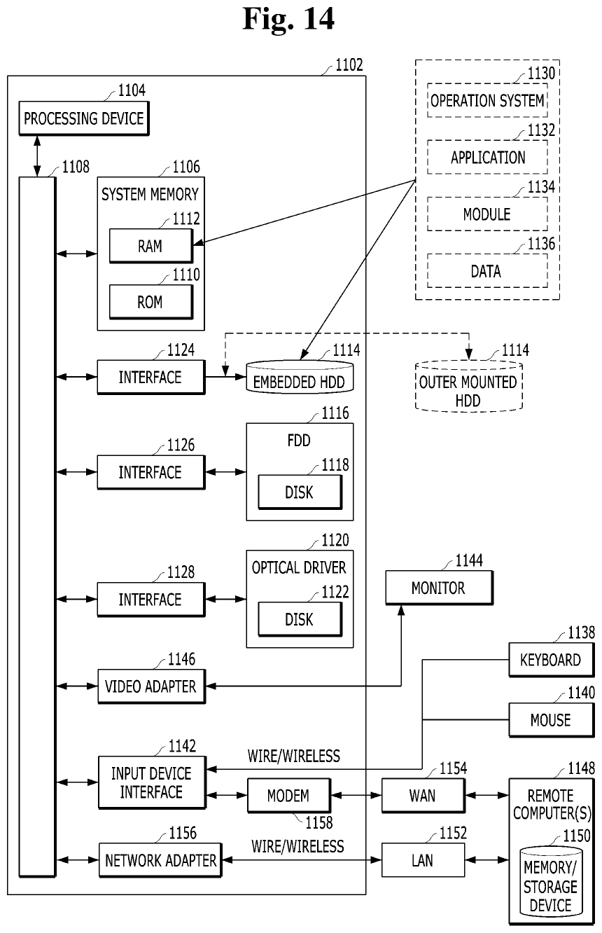

FIG. 14 is a simple and general schematic diagram illustrating an example of a computing environment in which exemplary embodiments of the present disclosure are implementable.

The present disclosure has been generally described concerning a computer-executable command executable in one or more computers, but those skilled in the art will appreciate well that the present disclosure may be implemented in combination with other program modules and/or in a combination of hardware and software.

In general, a module in the present specification includes a routine, a procedure, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini-computer, and a main frame computer.

The exemplary embodiments of the present disclosure may be carried out in a distributed computing environment, in which certain tasks are performed by remote processing devices connected through a communication network. In the distributed computing environment, a program module may be positioned in both a local memory storage device and a remote memory storage device.

The computer generally includes various computer readable media. A computer-accessible medium may be a computer readable medium regardless of the kind of medium, and the computer readable medium includes volatile and non-volatile media, transitory and non-non-transitory media, portable and non-portable media. As a non-limited example, the computer readable medium may include a computer readable storage medium and a computer readable transport medium.

The computer readable storage medium includes volatile and non-volatile media, transitory and non-transitory media, portable and non-portable media constructed by a predetermined method or technology, which stores information, such as a computer readable command, a data structure, a program module, or other data. The computer readable storage medium includes a random access memory (RAM), a read-only memory (ROM), electrically erasable and programmable ROM (EEPROM), a flash memory, or other memory technologies, a compact disc (CD)-ROM, a digital video disk (DVD), or other optical disk storage devices, a magnetic cassette, a magnetic tape, a magnetic disk storage device, or other magnetic storage devices, or other predetermined media, which are accessible by a computer and are used for storing desired information, but is not limited thereto.

The computer readable transport medium generally includes all of the information transport media, such as a carrier wave or other transport mechanisms, which implement a computer readable command, a data structure, a program module, or other data in a modulated data signal. The modulated data signal means a signal, of which one or more of the characteristics are set or changed to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a specific time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer-executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer-executable commands for performing the methods of the present disclosure.

A plurality of program modules including an operating system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated well that the present disclosure may be implemented by several commercially usable operation systems or a combination of operating systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a gamepad, a stylus pen, a touch screen, and the like. The foregoing and other input devices are frequently connected to the processing device 1104 through an input device interface 1142 connected to the system bus 1108, but maybe connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a server computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are generally in an office and a company and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication server on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 operates communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or maybe simply ad hoc communication between at least two devices.

The Wi-Fi enables a connection to the Internet and the like even without a wire. Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or maybe operated in a product including both bands (dual bands).

Those skilled in the art will appreciate that the various illustrative logical blocks, modules, processors, means, circuits, and algorithm operations described concerning the exemplary embodiments disclosed herein may be implemented by electronic hardware (for convenience, called “software” herein), various forms of program or design code, or a combination thereof. To clearly describe the compatibility of the hardware and the software, various illustrative components, blocks, modules, circuits, and operations are generally illustrated above concerning the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using standard programming and/or engineering technology. A term “manufactured article” includes a computer program, a carrier, or a medium accessible from a predetermined computer readable device. For example, the computer readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. A term “machine-readable medium” includes a wireless channel and various other media, which are capable of storing, holding, and/or transporting a command(s) and/or data, but is not limited thereto.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

1. A computer readable medium containing a computer program, wherein the computer program includes commands which cause a processor of a node included in a blockchain network to execute steps, the steps comprising:
recording at least one first transaction in a transaction table and a first body table when the at least one first transaction occurs;
generating first header information for the at least one first transaction when a preset condition is satisfied;
recording the first header information in a first header table; and
transmitting a signal including the at least one first transaction and the first header information to at least one node included in the blockchain network so that the at least one first transaction is recorded in a second body table of each of a plurality of nodes included in the blockchain network and the first header information is recorded in a second header table of each of the plurality of nodes included in the blockchain network.

2. The computer readable medium of claim 1, wherein the first header information comprises at least one of i) a time stamp indicating a time when the first header information is generated, ii) generation node information for a node that generates the first header information or iii) first identification information for identifying the first header information,
wherein each of the transaction table and the first body table comprises a first transaction table column in which the at least one first transaction is recorded, and a second transaction table column in which identification information on header information mapped to each of the at least one first transaction recorded in each transaction table row of the transaction table is recorded,
wherein the first header table comprises a first header table column in which the first identification information is recorded, a second header table column in which a hash value of previous header information is recorded, and a third header table column in which a hash value of the current header information is recorded.

3. The computer readable medium of claim 2, wherein the recording of the first header information in the first header table further comprises:
recording the first identification information in at least one first data cell corresponding to at least one first transaction table row and the second transaction table column in the transaction table, wherein the at least one first transaction table row is a transaction table row in which the at least one first transaction is recorded in the transaction table;
recording a null value in a second data cell corresponding to the second header table column and the first header table row in which the first header information is recorded; and
recording a null value in a third data cell corresponding to the third header table column and the first header table row.

4. The computer readable medium of claim 3, wherein the steps further comprise:
calculating a first hash value to be input to the first header information when performing consensus based on a preset consensus algorithm;
recognizing second header information having an order faster than that of the first header information based on a preset protocol;
recognizing a second hash value, which is a hash value of current header information input to the second header information;
transmitting the first hash value and the second hash value to the at least one node included in the blockchain network, thereby recognizing whether a consensus has been completed; and
when consensus is complete, recording the second hash value to the second data cell and recording the first hash value to the third data cell.

5. The computer readable medium of claim 4, wherein the calculating of the first hash value to be input to the first header information when performing consensus based on a preset consensus algorithm comprises:
checking whether the first header information recorded in the first header table is recorded in a second header table of each of the plurality of nodes included in the blockchain network when a preset consensus condition is satisfied; and
calculating the first hash value when the first header information is recorded in the second header table.

6. The computer readable medium of claim 5, wherein the preset consensus condition is satisfied at a preset time interval or when a number of uncommitted header information existing in the second header table exceeds a preset number.

7. The computer readable medium of claim 5, wherein the calculating of the first hash value when the first header information is recorded in the second header table comprises:
searching for at least one transaction related to the first header information in a transaction table of the node using the first identification information; and
hashing the at least one transaction based on a preset hash algorithm to calculate the first hash value.

8. The computer readable medium of claim 5, wherein the checking of whether the first header information recorded in the first header table is recorded in the second header table of each of the plurality of nodes included in the blockchain network when the preset consensus condition is satisfied comprises:
transmitting a first signal to the plurality of nodes to check whether the first header information is recorded in the second header table;
receiving a second signal from the plurality of nodes in response to the first signal; and
checking whether the first header information is recorded in the second header table based on the second signal, and
wherein the second signal comprises node identification information for the node that transmitted the second signal, and identifier indicating whether the first header information is recorded in the second header table.

9. The computer readable medium of claim 8, wherein the checking of whether the first header information is recorded in the second header table based on the second signal further comprises:
recognizing a first node based on the node identification information when the second signal received from the first node among the plurality of nodes includes a first identifier indicating that the first header information is not recorded in a header table of the first node; and
transmitting the first header information and the at least one first transaction related to the first header information to the first node.

10. The computer readable medium of claim 8, wherein the calculating of the first hash value when the first header information is recorded in the second header table further comprises:
recognizing that the first header information is recorded in the second header table when the second signal received from the plurality of nodes includes a second identifier indicating that the first header information is recorded in the first header table.

11. The computer readable medium of claim 4, wherein the first hash value is a value obtained by hashing the at least one first transaction using a preset hash algorithm, and
wherein the second hash value is a value obtained by hashing at least one transaction related to the second header information using the preset hash algorithm.

12. The computer readable medium of claim 1, wherein the preset condition is satisfied at a preset time interval or when a number of the at least one first transaction recorded in the transaction table exceeds a preset number.

13. The computer readable medium of claim 1, wherein the recording of the at least one first transaction in the transaction table and a first body table when the at least one first transaction occurs further comprises:
checking whether a size of a file exceeds a preset size when receiving a command to record the file to the blockchain network; and
determining a method of recording a second transaction including the file in the transaction table and the first body table based on whether the size of the file exceeds the preset size, and
wherein the transaction table and the first body table comprises a first transaction table column in which the at least one first transaction is recorded, a second transaction table column in which identification information on header information mapped to each of the at least one first transaction recorded in each transaction table row of the transaction table is recorded and a third transaction table column for recording location information indicating a location where the file is recorded in a storage unit of the node.

14. The computer readable medium of claim 13, wherein the determining of the method of recording of the second transaction including the file in the transaction table and the first body table is based on whether the size of the file exceeds the preset size comprises:
recording data representing the file in a binary format in a fourth data cell of the first transaction table column when the size of the file is less than or equal to the preset size; and
recording a null value to a fifth data cell of a third transaction table column positioned in a same row as the fourth data cell.

15. The computer readable medium of claim 13, wherein the determining of the method of recording the second transaction including the file in the transaction table and the first body table based on whether the size of the file exceeds the preset size comprises:
recognizing a hash value that hashed the file through a preset hash algorithm when the size of the file exceeds the preset size;
recording the file in a storage unit;
recording the hash value to a fourth data cell of the first transaction table column of the transaction table; and
recording the location information in a fifth data cell of the third transaction table column located in a same row as the fourth data cell.

16. The computer readable medium of claim 15, wherein the at least one first transaction comprises the second transaction including the file,
wherein the transmitting a signal including the at least one first transaction and the first header information to at least one node included in the blockchain network further comprises:
checking a setting for whether to share the file; and
determining whether to transmit the file together with the at least one first transaction including the second transaction and the first header information to the at least one node according to the setting.

17. The computer readable medium of claim 16, wherein the determining of whether to transmit the file together with the at least one first transaction including the second transaction and the first header information to the at least one node according to the setting comprises:
transmitting the file to the at least one node together with the at least one first transaction including the second transaction and the first header information when a first setting of sharing the file is set.

18. The computer readable medium of claim 16, wherein the determining of whether to transmit the file together with the at least one first transaction including the second transaction and the first header information to the at least one node according to the setting comprises:
determining not to transmit the file to the at least one node when a second setting of not sharing the file is set.

19. The computer readable medium of claim 15, wherein the recording of the location information in the fifth data cell of the third transaction table column located in the same row as the fourth data cell comprises:
checking a setting for whether to share the file; and
recording the location information in the fifth data cell when the first setting of sharing the file is set.

20. The computer readable medium of claim 15, wherein the recording of the location information in the fifth data cell of the third transaction table column located in the same row as the fourth data cell comprises:
checking a setting for whether to share the file; and
recording a null value to the fifth data cell instead of the location information when a second setting of not sharing the file is set.
